(19) United States
(12) Patent Application Publication
(10) Pub. No.: US 2015/0323349 A1
(43) Pub. Date: Nov. 12, 2015

(54) Sensor Arrangement for Sensing Rotation Angles on a Rotating Component in a Vehicle

(71) Applicant: Robert Bosch GmbH, Stuttgart (DE)

(72) Inventors: Remigius Has, Grafenau-Daetzingen (DE); Stefan Leidich, Rutesheim (DE); Markus Kienzle, Lehrensteinsfeld (DE)

(21) Appl. No.: 14/705,312

(22) Filed: May 6, 2015

(30) Foreign Application Priority Data
May 8, 2014 (DE) 10 2014 208 642.6

(51) Int. Cl. G01D 5/20

(52) U.S. Cl. CPC G01D 5/2013

(57) ABSTRACT

A sensor arrangement for sensing a rotation angle on a rotating component in a vehicle includes a first measurement transmitter. The first measurement transmitter is coupled at a periphery with a predefined first transmission ratio to the rotating component. The sensor arrangement includes a second measurement transmitter coupled at the periphery with a predefined second transmission ratio to the rotating component. The first and second measurement transmitters are mounted on a common axis of rotation. The first and second measurement transmitters generate, in conjunction with a corresponding first and second to measurement recorder, data configured to determine the current rotation angle of the rotating component.

This application claims priority under 35 U.S.C. §119 to patent application no. DE 10 2014 208 642.6 filed on May 8, 2014 in Germany, the disclosure of which is incorporated herein by reference in its entirety.

The disclosure relates to a sensor arrangement for sensing rotation angles on a rotating component in a vehicle according to the disclosed subject matter.

### BACKGROUND

With known steering angle sensors a counting wheel for determining the number of revolutions of the steering wheel is scanned contactlessly by means of magnetic field sensors. A system of this type has the disadvantage that when the ignition is switched off a static current has to be provided in order to identify a turning of the steering wheel when the ignition is switched off. If the vehicle continuously remains unused, this leads to an undesirable emptying of the vehicle battery. If such a static current is not provided, the steering angle can no longer be clearly determined when the steering wheel is turned when the ignition is switched off or the battery is disconnected.

New steering wheel measurement systems comprising two angle sensors that function in accordance with a modified nonius principle provide an improvement and no longer have the disadvantage of static current provision. However, alternative variants are of high interest for cost reasons.

DE 195 06 938 A1 for example thus discloses a method and a device for measuring the angle of a rotatable body. Here, the rotatable body cooperates at the periphery with at least two further rotatable bodies. The further rotatable bodies are formed for example as gearwheels, of which the angular position is determined with the aid of two sensors. The angular position of the rotatable body can then be determined from the angular positions thus determined of the two additional rotatable bodies. So that clear conclusions are possible, it is necessary that all three rotatable bodies or gearwheels each have a certain number of teeth or a certain transmission. The method and the device can be used for example in order to determine the steering angle of a motor vehicle. The described measurement principle can be applied to any angle sensor types, such as optical, magnetic, capacitive, inductive or resistive sensors. Here, the further rotatable bodies act as measurement transmitters and the corresponding sensors act as measurement recorders.

A sensor arrangement for sensing rotation angles on a rotating component in a vehicle is known from DE 10 2012 202 639 A1. The rotating component is coupled at the periphery thereof to a measurement transmitter, which, in conjunction with at least one sensor, generates a signal representing the rotation angle of the rotating component. Here, the measurement transmitter is formed as a movement converter, which converts the rotation of the rotating component into a translation of the measurement transmitter, the at least one sensor determining the traveled path of the measurement transmitter, which represents the rotation angle of the rotating component.

### SUMMARY

The sensor arrangement according to the disclosure for sensing rotation angles on a rotating component in a vehicle having the features of independent Claim 1 by contrast has the advantage that, in order to determine a rotation angle, such as a steering angle of a vehicle, using at least two measurement transmitters, a significantly reduced circuit board area is necessary. Here, the two measurement transmitters for ascertaining the rotation angle of a rotating component are mounted on a common axis of rotation and are arranged either on each side of a circuit board or only on one side of the circuit board. Due to the mounting of the two measurement transmitters on one axis of rotation, the projected base area on the corresponding circuit board is smaller. In the case of conventional sensor arrangements for sensing rotation angles on a rotating component in a vehicle, which sensor arrangements use at least two measurement transmitters, each of the measurement transmitters is arranged on its own axis of rotation, such that a much greater circuit board area is necessary. Embodiments of the sensor arrangement according to the disclosure can be used for example to implement the nonius method or for the redundant sensing of the rotation angle, for which at least two measurement transmitters are necessary in each case. Furthermore, it is possible in principle due to the arrangement on the common axis of rotation to directly measure the angle difference between the two measurement transmitters, this difference being of interest for the nonius method. In addition, a first measurement transmitter can sense the angular position of the rotating component within the range of a 360° rotation and a second measurement transmitter can serve as a tally counter, which detects a multiple revolution of the rotating component.

Embodiments of the sensor arrangement according to the disclosure for sensing rotation angles on a rotating component in a vehicle are used for example as steering angle sensors for determining the steering angle of a vehicle.

Embodiments of the present disclosure provide a sensor arrangement for sensing rotation angles on a rotating component in a vehicle. Here, a first measurement transmitter is coupled at the periphery with a predefined first transmission ratio to the rotating component and a second measurement transmitter is coupled at the periphery with a predefined second transmission ratio to the rotating component. The measurement transmitters generate, in each case in conjunction with at least one measurement recorder, at least one piece of information for ascertaining the current rotation angle of the rotating component. In accordance with the disclosure the two measurement transmitters are mounted on a common axis of rotation.

Due to the measures and developments specified in the dependent claims, advantageous improvements of the sensor arrangement specified in independent Claim 1 for sensing rotation angles on a rotating component in a vehicle are possible.

A sleeve particularly advantageously can be coupled to the rotating component for conjoint rotation therewith, the sleeve having entrainment means on the inner periphery and at least one primary gear rim on the outer periphery. Here, the first measurement transmitter can be formed as a first gearwheel having a first gear rim, and the second measurement transmitter can be formed as a second gearwheel having a second gear rim. Here, the at least one primary gear rim meshes with the first gear rim of the first measurement transmitter and with the second gear rim of the second measurement transmitter and rotates the measurement transmitters. The two gearwheels may have a different transmission with respect to the primary gearwheel in spite of a same axial distance. For this purpose the two gear rims of the gearwheels may have different toothing modules, and the primary gear rim is divided accordingly and has two toothings formed accordingly. Another possibility lies in forming the primary gear rim likewise in a divided manner with two toothings, which have the same toothing module, but a different number of teeth. In this embodiment the divided primary gear rim has two different diameters. The two smaller gearwheels are toothed such that the same axial distance is set. A combination of different number of teeth and a different module is also possible.

In an advantageous embodiment of the sensor arrangement according to the disclosure each measurement transmitter may have at least one metal region, and the at least one measurement recorder can be formed as an eddy current sensor having at least one detection coil, which is arranged on at least one circuit board and cooperates with the metal regions of the measurement transmitters. The at least one detection coil can be formed for example as a spiral coil or as a sector cordial, which each can be arranged as flat coils on the surface of the circuit board. With utilization of the eddy current effect, the overlap of the least one detection coil with a metal object or the variation of the distance of the at least one detection coil from a metal object influences the inductance of the at least one detection coil, which can be measured in a suitable manner.

In a further advantageous embodiment of the sensor arrangement according to the disclosure at least one of the two measurement transmitters together with at least one measurement recorder can form a rotation angle sensor, which senses a rotation angle of the corresponding measurement transmitter. Such a rotation angle sensor senses an angular position of the rotating corresponding measurement transmitter within the range of a 360° rotation, the axial distance of the measurement transmitter in relation to the at least one detection coil of the corresponding measurement recorder being constant.

In a further advantageous embodiment of the sensor arrangement according to the disclosure the at least one detection coil of a first measurement recorder can be arranged on a first surface of the circuit board, and the at least one detection coil of a second measurement recorder can be arranged on a second surface of the circuit board. Here, the circuit board is arranged between the measurement transmitters, such that the at least one metal region of the first measurement transmitter faces toward the least one detection coil of the first measurement recorder, and the at least one metal region of the second measurement transmitter faces toward the least one detection coil of the second measurement recorder. It is thus possible to allow both measurement transmitters to run on a shaft without thread at a constant distance from the at least one detection coil of the respective measurement recorder. In this case the angular position of both measurement transmitters is detected and analyzed via the nonius method.

In a further advantageous embodiment of the sensor arrangement according to the disclosure the first transmission ratio can be identical to the second transmission ratio and at least one of the two measurement transmitters together with a threaded pin can form a movement converter, which converts the rotation of the rotating component into a rotation with axial translation of the corresponding measurement transmitter. Here, the at least one measurement recorder together with the corresponding measurement transmitter forms a distance sensor, which ascertains the axial distance of the at least one metal region of the corresponding measurement transmitter from the at least one detection coil of the at least one measurement recorder. The at least one second measurement recorder formed as a distance sensor advantageously ascertains a traveled axial path of the second measurement transmitter as information for ascertaining the number of revolutions of the rotating component. The rotation of the rotatable component thus leads to a variation of the distance between the detection coils and the metal regions of the measurement transmitters. In this embodiment it is not absolutely necessary to use two gearwheels in order to determine, one-on-one, the rotation angle of the rotating component by the conversion into a movement in translation over more than one revolution. The second measurement transmitter can be used in order to provide a redundancy.

It is, however, also possible to form one of the measurement transmitters arranged on an axis of rotation as part of a distance sensor with variable distance from the at least one detection coil of the corresponding measurement recorder, and to form the other measurement transmitter as part of a rotation angle sensor with constant distance from the at least one detection coil of the corresponding measurement recorder. In this embodiment, in addition to the distance measurement of the first measurement transmitter, the angle position of the second measurement transmitter is also detected. The advantage of this solution lies in the fact that the angle measurement of the second measurement transmitter without threaded pin within a 360° rotation can be taken very accurately by means of a corresponding design of the detection coils of the measurement recorder, and the distinction of multiple revolutions is provided by the measurement of the distance of the first measurement transmitter with threaded pin. A distinction can be made between approximately 10 revolutions with appropriate thread pitch.

In a further advantageous embodiment of the sensor arrangement according to the disclosure the measurement transmitters can be arranged facing toward the same surface of the circuit board, the first measurement transmitter having a shorter distance from the surface of the circuit board than the second measurement transmitter. Great assembly advantages are provided as a result of this particularly advantageous arrangement of the two measurement transmitters.

The at least one metal region of the first measurement transmitter and the at least one detection coil of a first measurement recorder can form for example a first rotation angle sensor, and the at least one metal region of the second measurement transmitter and the at least one detection coil of a second measurement recorder can form a second rotation angle sensor. Here, the at least one metal region and the least one detection coil of the first rotation angle sensor can be arranged closer to the axis of rotation than the at least one metal region and the at least one detection coil of the second rotation angle sensor. Due to the separate physical arrangement of the detection coils of the measurement recorders and of the metal regions of the measurement transmitters, the detection coils of the measurement recorders are influenced individually by the metal regions of the measurement transmitters. As a result of this construction with two measurement transmitters on one circuit board side, the angular position of the two measurement transmitters can therefore be measured individually.

Alternatively, the at least one metal region of the first measurement transmitter together with the at least one detection coil of a single measurement recorder can form a first rotation angle sensor, and the at least one metal region of the second measurement transmitter together with the at least one detection coil of the single measurement recorder can form a second rotation angle sensor. In order to individually ascertain the rotary position of the individual measurement transmitters, the at least one metal region of the first measurement transmitter can be thinner than the at least one metal region of the second measurement transmitter. Here, the at least one detection coil of the measurement recorder can be excited successively using various frequencies and can be analyzed, in order to ascertain the rotary position of the first measurement transmitter the at least one detection coil being excited using a higher frequency than in order to ascertain the rotary position of the second measurement transmitter. Due to the thinner design of the metallization of the first measurement transmitter arranged closer to the circuit board, the thinner metal region of the first measurement transmitter can be penetrated by the excitation of the least one detection coil using a lower frequency, of for example approximately 2 MHz, and the angular position of the second measurement transmitter having the thicker metal region can be sensed selectively. Due to the subsequent operation of the at least one detection coil at a higher frequency, of for example approximately 50 MHz, the angular position of the first measurement transmitter can be measured. Since the second measurement transmitter having the thicker metal region influences the at least one detection coil also at higher frequencies, it is to be expected that the angular position of the second measurement transmitter will influence the measurement of the angular position of the first measurement transmitter. However, since as already described the angular position of the second measurement transmitter can be determined in a manner undisturbed by the first measurement transmitter, the influence on the measurement of the first measurement transmitter can be mathematically corrected.

Alternatively, the at least one metal region of the first measurement transmitter and the at least one metal region of the second measurement transmitter can cooperate with the least one detection coil of just one measurement recorder, such that an angle difference between the rotary position of the first measurement transmitter and the rotary position of the second measurement transmitter can be ascertained directly.

In a further advantageous embodiment of the sensor arrangement according to the disclosure the single measurement recorder may have a plurality of detection coils formed as sector coils, which can be excited and analyzed simultaneously or in a predefined order. The position of the metal regions or the position of the fronts of the metal regions of the measurement transmitters can thus be determined more accurately. In addition, the detection coils formed as sector coils can be arranged in a manner overlapping in various planes of the circuit board. A front of a metal region of the measurement transmitter can thus advantageously be prevented from coming to lie precisely between two detection coils, where it therefore potentially may not be detected.

Exemplary embodiments of the disclosure are illustrated in the drawings and will be explained in greater detail in the following description. In the drawings like reference signs denote components or elements that perform like or similar functions.

### BRIEF DESCRIPTION OF THE DRAWINGS

FIG. 1 shows a schematic perspective illustration of a first exemplary embodiment of a sensor arrangement according to the disclosure for sensing rotation angles on a rotating component in a vehicle.

FIG. 2 shows a schematic perspective sectional illustration of a second exemplary embodiment of a sensor arrangement according to the disclosure for sensing rotation angles on a rotating component in a vehicle.

FIG. 3 shows a schematic plan view of a rotation angle sensor for the sensor arrangement according to the disclosure from FIG. 1 or 2.

FIG. 4 shows a schematic sectional illustration of a third exemplary embodiment of a sensor arrangement according to the disclosure for sensing rotation angles on a rotating component in a vehicle.

FIG. 5 shows a schematic plan view of a first measurement transmitter for the sensor arrangement according to the disclosure from FIG. 4.

FIG. 6 shows a schematic plan view of a second measurement transmitter for the sensor arrangement according to the disclosure from FIG. 4.

FIG. 7 shows a schematic plan view of a measurement recorder for the sensor arrangement according to the disclosure from FIG. 4.

FIG. 8 shows a plan view of a first angle difference position of the measurement transmitters of the sensor arrangement according to the disclosure from FIG. 4 at 0°.

FIG. 9 shows a plan view of an angle difference position of the measurement transmitters of the sensor arrangement according to the disclosure from FIG. 4 at 180°.

FIG. 10 shows a schematic plan view of a difference angle sensor for the sensor arrangement according to the disclosure from FIG. 4.

FIG. 11 shows a schematic sectional illustration of a fourth exemplary embodiment of a sensor arrangement according to the disclosure for sensing rotation angles on a rotating component in a vehicle.

FIG. 12 shows a characteristic curve graph for illustrating the nonius principle over the rotation angle of the rotating component.

### DETAILED DESCRIPTION

As can be seen from FIGS. 1 to 11 the illustrated exemplary embodiments of a sensor arrangement 1, 1A, 1B, 1C, 1D according to the disclosure for sensing rotation angles ψ on a rotating component 10 in a vehicle each comprise a first measurement transmitter 20, 20A, 20B, 20C, 20D, which is coupled at the periphery with a predefined first transmission ratio to the rotating components 10, and a second measurement transmitter 40, 40A, 40B, 40C, 40D, which is coupled at the periphery with a predefined second transmission ratio to the rotating component 10. Here, the measurement transmitters 20, 20A, 20B, 20C, 20D, 40, 40A, 40B, 40C, 40D generate, in each case in conjunction with at least one measurement recorder 30, 30A, 30B, 30C, 30D, 30E, 50, 50A, 50B, 50E, at least one piece of information for ascertaining the current rotation angle ψ of the rotating component 10. In accordance with the disclosure the two measurement transmitters 20, 20A, 20B, 20C, 20D, 40, 40A, 40B, 40C, 40D are mounted on a common axis of rotation DA.

As can also be seen from FIGS. 1 to 11 in each of the illustrated exemplary embodiments of the sensor arrangement 1, 1A, 1B, 1C, 1D according to the disclosure a sleeve 10A is coupled to the rotating component 10 for conjoint rotation therewith. For this purpose the sleeve 10A has an entrainment means 16 on the inner periphery. The first measurement transmitter 20, 20A, 20B, 20C, 20D is formed as a first gearwheel 22 having a first gear rim 24, and the second measurement transmitter 40, 40A, 40B, 40C is formed as a second gearwheel 42 having a second gear rim 44. For coupling to the first and second measurement transmitters 20, 20A, 20B, 20C, 20D, 40, 40A, 40B, 40C, 40D the sleeve 10A has at least one primary gear rim 18 on the outer periphery, which meshes with the first gear rim 24 of the first measurement transmitter 20, 20A, 20B, 20C, 20D and with the second gear rim 44 of the second measurement transmitter 40, 40A, 40B, 40C and rotates the measurement transmitters 20, 20A, 20B, 20C, 20D, 40, 40A, 40B, 40C, 40D. The at least one primary gear rim 18 is arranged on a disc-shaped main body 17, which is formed in one piece with the sleeve 10A.

The two gearwheels 22, 42 have a different transmission with respect to the primary gear rim 18 of the sleeve 10A in spite of the same axial distance. For this purpose a different module of the toothing can be used. The toothing of the primary gear rim 18 is therefore divided approximately centrally into a first toothing 18.1 and a second toothing 18.2, which have different modules. Another possibility is to centrally divide the primary gear rim 18, which with identical module then has a different number of teeth. With this solution different diameters are given for the two toothings 18.1, 18.2. The two smaller gearwheels 22, 42 are toothed such that the same axial distance is set. A combination of different number of teeth and different module is also possible.

In the illustrated embodiments of the sensor arrangement 1, 1A, 1B, 1C, 1D according to the disclosure the at least one measurement recorder 30, 30A, 30B, 30C, 30D, 30E, 50, 50A, 50B, 50E is formed as eddy current sensor with a predefined number of detection coils 66, which are arranged on at least one circuit board 60 and cooperate with metal regions 26, 46 of the measurement transmitters 20, 20A, 20B, 20C, 20D, 40, 40A, 40B, 40C, 40D. The at least one detection coil 66 can be formed as a spiral coil 66B or as a sector coil 66A. The detection coils 66 thus generate corresponding magnetic fields, which are influenced by the movement or by the position of the two measurement transmitters 20, 20A, 20B, 20C, 20D, 40, 40A, 40B, 40C, 40D, such that an analysis and control unit (not illustrated) can analyze the influence on the magnetic fields and the change of inductance of the detection coils 66. The analysis and control unit can analyze the detection coils of the at least one measurement recorder 30, 30A, 30B, 30C, 30D, 30E, 50, 50A, 50B, 50E simultaneously or in a predefined order. In the illustrated exemplary embodiments the detection coils 66 are formed as planar coils arranged directly on the circuit board 60, 60A, 60B, 60C, 60D. However, other production platforms are also conceivable, such as silicon. The sensor effect is based on the eddy current effect. Specifically, the overlap of the at least one detection coil 66 with a metal region 26, 46 of the respective measurement transmitter 20, 20A, 20C, 20D, 40, 40A, 40B, 40C, 40D or a distance of the at least one detection coil 66 from a metal region 26, 46 of the respective measurement transmitter 20B influences the inductance of the at least one detection coil 66, which is measured in a suitable manner.

In the illustrated exemplary embodiments of the sensor arrangement 1 according to the disclosure the metal regions 26, 46 of the measurement transmitters 20, 20A, 20B, 20C, 20D, 40, 40A, 40B, 40C, 40D are formed as insert parts, which are introduced into the main body of the measurement transmitters 20, 20A, 20B, 20C, 20D, 40, 40A, 40B, 40C, 40D. In an embodiment as a distance sensor the corresponding measurement transmitters 20, 30 can be produced completely from a metal material.

As can also be seen from FIGS. 1 to 3 the two measurement transmitters 20A, 20B, 40A, 40B are arranged on a common axis of rotation DA on either side of the circuit board 60A, 60B. The two measurement transmitters 20A, 40A are mounted rotatably on a common stud bolt 2A, 2B, which runs through the circuit board 60A, 60B. The at least one detection coil 66 of a first measurement recorder 30A, 30B is arranged on a first surface 62 (here the upper side) of the circuit board 60A, 60B. The at least one detection coil 66 of a second measurement recorder 50A, 50B is arranged on a second surface 64 (here the underside) of the circuit board 60A, 60B. The detection coils 66 of the first and second measurement recorder 30A, 30B, 50A, 50B can be electrically separated from one another by a screen plane (not illustrated) buried in the circuit board 60A, 60B. The circuit board 60A, 60B is arranged between the measurement transmitters 20A, 20B, 40A, 40B such that the at least one metal region 26 of the first measurement transmitter 20A, 20B faces toward the at least one detection coil 66 of the first measurement recorder 30A, 30B, and the at least one metal region 46 of the second measurement transmitter 40A, 40B faces toward the least one detection coil 66 of the second measurement recorder 50A, 50B.

As can also be seen from FIG. 1 in the illustrated first exemplary embodiment of the sensor arrangement 1A according to the disclosure the first measurement transmitter 20A with the first measurement recorder 30A and the second measurement transmitter 40A with the second measurement recorder 50A each form a rotation angle sensor 3A, 3B, from which a rotation angle α1, α2 of the corresponding measurement transmitter 20A, 40A is sensed individually. In this embodiment the axial distance between the measurement transmitters 20A, 40A and the corresponding measurement recorders 30A, 50A is constant. On the basis of the sensed rotation angles α1, α2 of the measurement transmitters 20A, 40A, the rotation angle Ψ of the rotating component 10 can then be clearly determined via a nonius method, even with multiple revolutions, as can be seen from the characteristic curve graph according to FIG. 12.

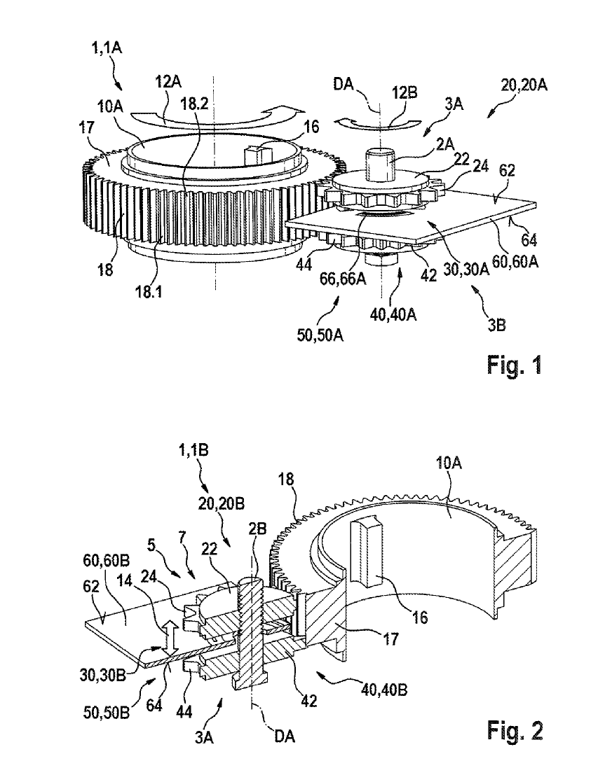

As can also be seen from FIG. 2 in the illustrated second exemplary embodiment of the sensor arrangement 1B according to the disclosure the first measurement transmitter 20B with the first measurement recorder 30B forms a distance sensor 5, which ascertains the axial distance between the first measurement transmitter 20B and the first measurement recorder 30B. The second measurement transmitter 40B together with the second measurement recorder 50B forms a rotation angle sensor 3A, which senses a rotation angle of the corresponding measurement transmitter 40B. In this embodiment the axial distance between the first measurement transmitter 20B and the corresponding first measurement recorder 30A is dependent on the number of revolutions of the rotating component 10, and the axial distance between the second measurement transmitter 40B and the corresponding second measurement recorder 50B is constant, by contrast. In the illustrated second exemplary embodiment the first measurement transmitter 20B together with a threaded pin 2B forms a movement converter 7, which converts the rotation 12A of the rotating component 10 into a rotation 12B with axial translation 14 of the corresponding measurement transmitter 20B. The distance sensor 5 formed from the first measurement recorder 30B with the corresponding first measurement transmitter 20B senses the axial distance of the at least one metal region 26 of the first measurement transmitter 20B from the at least one detection coil 66 of the first measurement recorder 30B and generates, on the basis of the traveled axial path 14 of the first measurement transmitter 20B, a piece of information for ascertaining the number of revolutions of the rotating component 10. In the illustrated second exemplary embodiment the first transmission ratio and the second transmission ratio are identical. The second measurement transmitter 40B is arranged on a thread-free region of the threaded pin 2B and performs only a rotary movement about the common axis of rotation DA.

In an exemplary embodiment that is not illustrated the second measurement transmitter 40B together with the second measurement recorder 50B can also form a distance sensor 5, which ascertains the axial distance between the second measurement transmitter 40B and the second measurement recorder 50B. In this exemplary embodiment both measurement transmitters 20B, 40B together with the threaded pin 2B can form a movement converter 7. The rotation of the measurement transmitters 20B, 40B thus leads to a variation of the distance between the detection coils 66 and the metal regions 26, 26 of the measurement transmitters. In this case it is not absolutely necessary to use two measurement transmitters 20B, 40B in order to determine, one-on-one, the rotation angle of the rotating component 10 over more than one revolution, however the additional distance sensor 5 can be used to provide a redundancy.

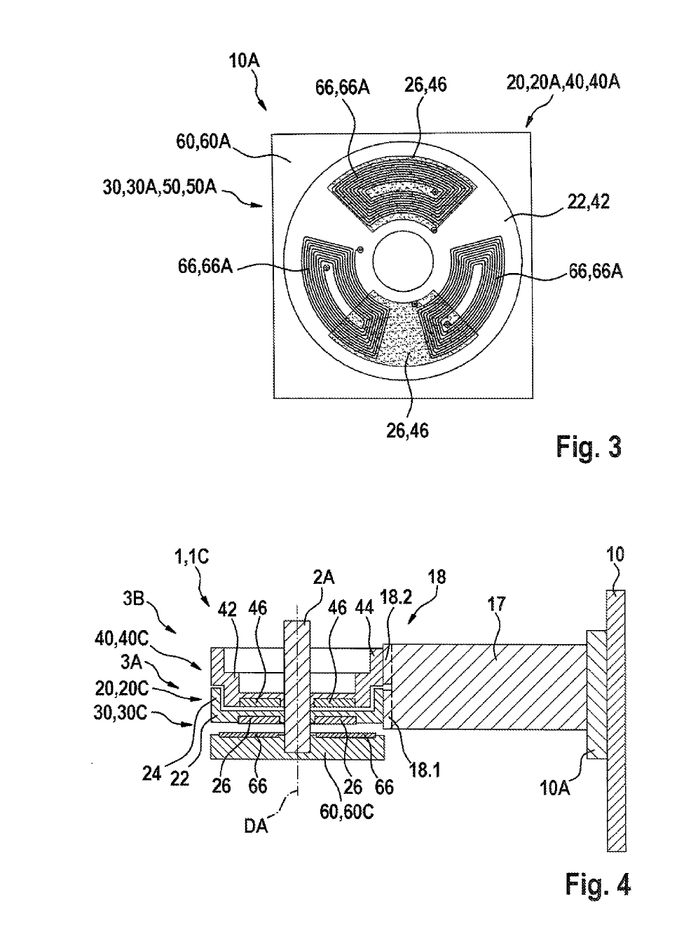

As can be seen from FIG. 3 the measurement recorders 30A, 50A, 50B of the rotation angle sensors 3A, 3B each comprise three detection coils 66, which are formed as sector coils 66A, are arranged in the form of a circle, and are distributed uniformly in the region of overlap with the measurement transmitters 20A, 40A, 40B. The corresponding measurement transmitters 20A, 40A, 40B each comprise two metal regions 26, 46. The angle measurement can thus be performed very accurately. The number and geometry of the detection coils 66 for the respective rotation angle sensor 3A, 3B can be varied. However, further variations in particular with regard to the number of detection coils 66 are quite conceivable. The same is true for the number and geometry of the metal regions 26, 46 in the rotating measurement transmitter 20A, 40A, 40B.

As can also be seen from FIG. 4 in the illustrated third exemplary embodiment of the sensor arrangement 1C according to the disclosure the two measurement transmitters 20C, 40C formed as gearwheels 22, 42 are mounted rotatably on a stud bolt 2A and run over a common axis of rotation DA. In addition both measurement transmitters 20C, 40C are arranged on one side of the circuit board 60C, on which the at least one detection coil 66 of a common measurement recorder 30C is arranged. Great assembly advantages are thus provided.

In the illustrated third exemplary embodiment of the sensor arrangement 1C according to the disclosure the rotation angles α1, α2 of the corresponding measurement transmitter 20C, 40C are either individually measured, or the angle difference between the measurement transmitters 20C, 40C can be measured directly. The individual measurement of the rotation angles α1, α2 of the corresponding measurement transmitter 20C, 40C requires the ability to distinguish between the metal regions 26, 46 of the two measurement transmitters 20C, 40C. A possibility of the separation of the metal regions 26, 46 can be provided via the thickness of the metal region 26, 46. When the at least one metal region 26 of the first measurement transmitter 20C, which is arranged closer to the circuit board 60C, is thinner than at least one metal region 46 of the second measurement transmitter 40C, which is further away from the circuit board 60C, the thinner metal region 26 can be penetrated by exciting the at least one detection coil 66 using a lower frequency, of for example approximately 2 MHz, and the thicker metal region 46 or the angular position of the second measurement transmitter 40C can be sensed selectively. Due to the subsequent excitation of the at least one detection coil 66 using a higher frequency, of for example approximately 50 MHz, the position of the first measurement transmitter 20C can be measured. Since the thicker metal region 46 of the second measurement transmitter 40C influences the at least one detection coil 66, also at higher frequencies, it is to be expected that the position of the second measurement transmitter 40C will influence the measurement of the position of the first measurement transmitter 20C. Since, as mentioned above, the position of the second measurement transmitter 40C can be determined in a manner undisturbed by the first measurement transmitter 20C, the influence on the measurement of the first measurement transmitter 20C can be mathematically corrected.

With the direct sensing of the angle difference between the measurement transmitters 20C, 40C, the effective active metal area of the metal regions 26, 46 is ascertained, this covering the at least one detection coil 66 of the common measurement recorder 30C and thus influencing the inductance of the at least one detection coil 66.

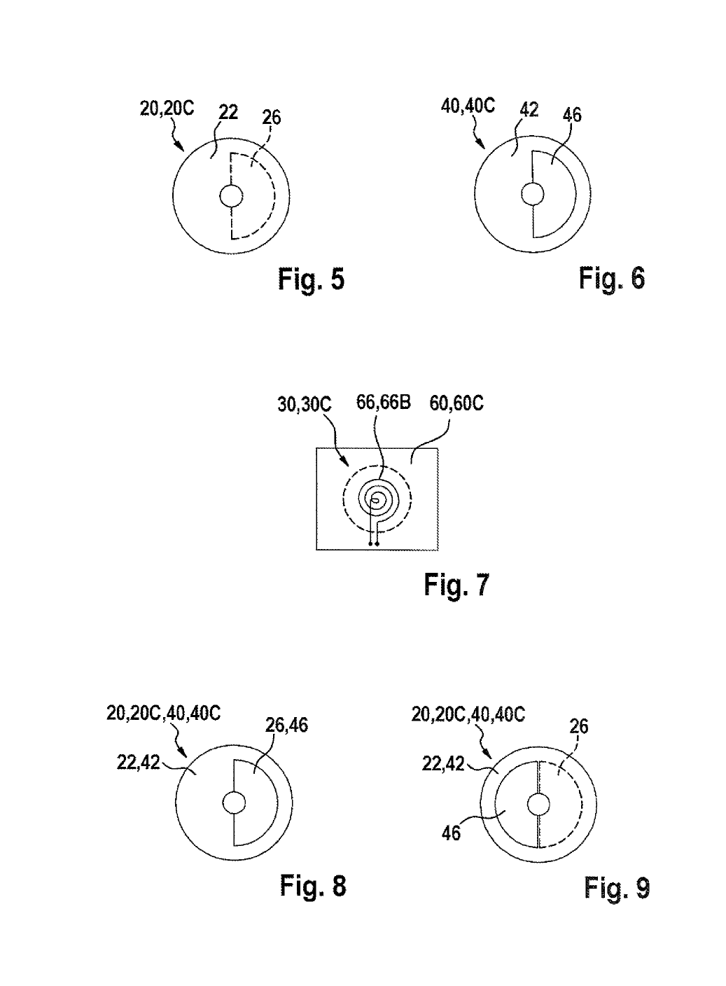

As can be seen from FIGS. 5 and 6, the two measurement transmitters 20C, 40C are each formed with a semi-circular metal region 26, 46. A single spiral coil 66B according to FIG. 7 can be used as detection coil 66 for the common measurement recorder 30C. FIGS. 8 and 9 each show the effectively active metal area in two angle difference positions (extreme positions) of the two measurement transmitters 20C, 40C, wherein FIG. 8 shows an angle difference of 0° and FIG. 9 shows an angle difference of 180°. The angle difference is produced by the different transmission ratio of the two measurement transmitters 20C, 40C. In the case of a first transmission ratio between the primary gear rim 18 and the first gear rim 24 of the first measurement transmitter 20C of 42:26 and a second transmission ratio between the primary gear rim 18 and the second gear rim 44 of the second measurement transmitter 40C of 42:28, an angle difference of 180° is set between the two measurement transmitters 20C, 40C after just 4.3 revolutions (1560°) of the primary gear rim 18 (α1=1560°*42/26=2520°; α2=1560°*42/28=2340°; α1−α2=180°), as is clear from FIG. 12. The illustrated third exemplary embodiment thus allows the absolute angle determination of the rotating component 10 inclusive of the identification of multiple revolutions.

An inherent disadvantage of the third exemplary embodiment of the sensor arrangement 1C according to the disclosure with the detection coil 66 formed as a spiral coil 66B concerns the angular resolution. The material measure of the difference angle sensor is formed by the change of the inductance of the detection coil 66 formed as spiral coil 66B. In practice a relative change of the inductance of just 30% will be the difference between a complete overlap of the spiral coil 66B by the metal regions 26, 46 of the two measurement transmitters 20C, 40C and no overlap. Since an overlap of the spiral coil 66B of 50% represents the minimum, 15300 angular positions will be identified with a desired angular resolution of the rotation angle Ψ of the rotating component 10 of 0.1°. This is technically sophisticated with a relative inductance change of 15%.

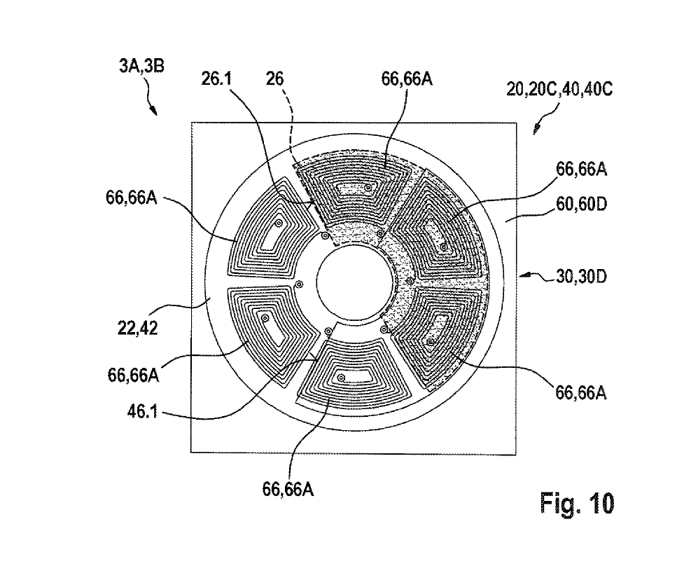

This disadvantage can be overcome with the use of a common measurement recorder 30D illustrated in FIG. 10 having six detection coils 66 formed as sector coils 66A and arranged in the form of a circle. The measurement transmitters 20C, 40C illustrated in FIGS. 5 and 6 are used as measurement transmitters 20C, 40C and each have a semi-circular metal region 26, 46. FIG. 10 shows the effectively active metal area of the two metal regions 26, 46 with an angle difference between the two measurement transmitters 20C, 40C of approximately 45°. The area projected onto the common measurement recorder 30D can be determined on the basis of the non-overlapped, fully overlapped and partially overlapped sector coils 66A. The information concerning the multiple revolution of the rotating component 10 is thus still provided. The significantly smaller sector coils 66A can, however, in addition more accurately identify the position of the fronts 26.1, 46.1 of the metal region 26, 46. With a rotation of the primary gear rim 18 or of the rotating component 10 by 0.1°, the front 26.1 of the metal region 26 of the first measurement transmitter 20C moves by 0.1°*(42/26)=0.16°, and the front 46.1 of the metal region 46 of the second measurement transmitter 40C moves by 0.1°*(42/28)=1.5°. Since each sector coil 66A occupies approximately 60° of the circle segment, a change of the overlap by approximately just 1.5° leads to a relative change of the inductance by (30%*(1.5/60))=0.78%. This value is much higher than in the case of the spiral coil 66B according to FIG. 7. There the relative change of inductance is (30%/15300)=0.00196%.

In an exemplary embodiment that is not illustrated of the sensor arrangement 1 according to the disclosure the six or more detection coils 66 can also be partially nested inside one another. It is thus possible to prevent the front 26.1, 46.1 of the metal region 26, 46 from coming to lie precisely between two detection coils 66, where it therefore potentially may not be detected. To this end the angle of the detection coils 66 can be enlarged for example from 60° to 70°. The penetration can be prevented by use of a number of circuit board planes.

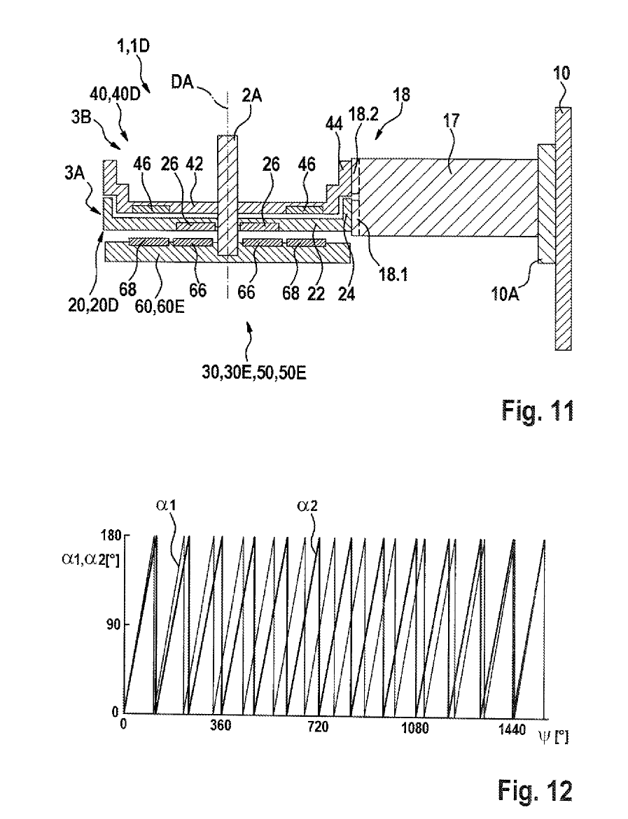

As can also be seen from FIG. 11 the two measurement transmitters 20D, 40D in the illustrated fourth exemplary embodiment of the sensor arrangement 1D according to the disclosure, similarly to the third exemplary embodiment, are arranged on one side of the circuit board 60E. In the illustrated fourth exemplary embodiment of the sensor arrangement 1D according to the disclosure the angular position of the two measurement transmitters 20D, 40D can be measured individually. To this end there is an inner measurement recorder 30E having at least one detection coil 66, which is overlapped only by a metal region 26 of the first measurement transmitter 20D. Here the metal region 26 of the first measurement transmitter 20D is likewise arranged in the inner region, i.e. in the vicinity of the stud bolt 2A. Furthermore, there is an outer measurement recorder 50E having at least one detection coil 66, which is covered only by a metal region 46 of the second measurement transmitter 40D. Here, the metal region 46 of the second measurement transmitter 40D is arranged likewise in the outer region, i.e. further away from the stud bolt 2A. The metal regions 26, 46 of the two measurement transmitters 20D, 40D thus influence the detection coils 66 individually.

Embodiments of the sensor arrangement according to the disclosure are preferably used as a steering angle sensor for determining the steering angle of a vehicle.

What is claimed is:

1. A sensor arrangement for sensing a rotation angle on a rotating component in a vehicle, comprising:
a first measurement transmitter coupled at a periphery with a predefined first transmission ratio to the rotating component; and
a second measurement transmitter coupled at the periphery with a predefined second transmission ratio to the rotating component, the first and second measurement transmitters configured to be mounted on a common axis of rotation and generate, in conjunction with a corresponding first and second measurement recorder, data in order to determine the current rotation angle of the rotating component.

2. The sensor arrangement according to claim 1, further comprising:
a sleeve coupled to the rotating component for conjoint rotation therewith, the sleeve having an entrainment structure on an inner periphery and at least one primary gear rim on a outer periphery, the first measurement transmitter comprises a first gearwheel having a first gear rim, the second measurement transmitter comprises a second gearwheel having a second gear rim, and the at least one primary gear rim configured to mesh with the first gear rim of the first measurement transmitter and with the second gear rim of the second measurement transmitter and rotate the first and second measurement transmitters.

3. The sensor arrangement according to claim 1, wherein each of the first and second measurement transmitters has at least one metal region, each of the first and second measurement recorders comprises an eddy current sensor having at least one detection coil, and the at least one detection coil of the first and second measurement recorders are configured to be arranged on the circuit board and cooperate with the at least one metal region of the first and second measurement transmitters.

4. The sensor arrangement according to claim 3, wherein the at least one detection coil comprises a spiral coil or a sector coil.

5. The sensor arrangement according to claim 3, wherein at least one of the first and second measurement transmitters forms a rotation angle sensor with the corresponding first and second measurement recorder and the rotation angle sensor is configured to sense a rotation angle of the corresponding first or second measurement transmitter.

6. The sensor arrangement according to claim 3, wherein the at least one detection coil of the first measurement recorder is arranged on a first surface of the circuit board and the at least one detection coil of the second measurement recorder is arranged on a second surface of the circuit board, the circuit board being arranged between the first and second measurement transmitters such that the at least one metal region of the first measurement transmitter faces toward the at least one detection coil of the first measurement recorder and the at least one metal region of the second measurement transmitter faces toward the at least one detection coil of the second measurement recorder.

7. The sensor arrangement according to claim 6, wherein the first transmission ratio is identical to the second transmission ratio, at least one of the first and second measurement transmitters forms a movement converter with a threaded pin, the movement converter is configured to convert a rotation of the rotating component into a rotation with axial translation of the corresponding first or second measurement transmitter, the first or second measurement recorder forming a distance sensor with the corresponding measurement transmitter, the distance sensor configured to determine an axial distance of the at least one metal region of the corresponding first or second measurement transmitter from the at least one detection coil of the first and second measurement recorder.

8. The sensor arrangement according to claim 7, wherein the second measurement recorder comprises a distance sensor and is configured to determine a traveled axial path of the second measurement transmitter in order to determine a number of revolutions of the rotating component.

9. The sensor arrangement according to claim 3, wherein the first and second measurement transmitters are arranged facing toward a same surface of the circuit board, the first measurement transmitter having a shorter distance from the surface of the circuit board than the second measurement transmitter.

10. The sensor arrangement according to claim 9, wherein the at least one metal region of the first measurement transmitter and the at least one detection coil of a first measurement recorder form a first rotation angle sensor and the at least one metal region of the second measurement transmitter and the at least one detection coil of a second measurement recorder form a second rotation angle sensor, the at least one metal region and the at least one detection coil of the first rotation angle sensor being arranged closer to the axis of rotation than the at least one metal region and the at least one detection coil of the second rotation angle sensor.

11. The sensor arrangement according to claim 9, wherein the at least one metal region of the first measurement transmitter forms a first rotation angle sensor with the at least one detection coil of a single measurement recorder and the at least one metal region of the second measurement transmitter forms a second rotation angle sensor with the at least one detection coil of the single measurement recorder.

12. The sensor arrangement according to claim 11, wherein the at least one metal region of the first measurement transmitter is thinner than the at least one metal region of the second measurement transmitter, the at least one detection coil of the measurement recorder is configured to be excited successively using a plurality of frequencies and being analyzed in order to determine the rotary position of the first measurement transmitter, and the at least one detection coil is configured to be excited using a higher frequency than in order to ascertain the rotary position of the second measurement transmitter.

13. The sensor arrangement according to claim 9, wherein the at least one metal region of the first measurement transmitter and the at least one metal region of the second measurement transmitter are configured to cooperate with the at least one detection coil of just one measurement recorder, in order to directly determine an angle difference between the rotary position of the first measurement transmitter and the rotary position of the second measurement transmitter.

14. The sensor arrangement according to claim 9, wherein the measurement recorder has a number of detection coils that comprise sector coils and the sector coils are configured to be excited and analyzed simultaneously or in a predefined order.

15. The sensor arrangement according to claim 14, wherein the detection coils comprise sector coils, the sector coils being configured to be arranged in a manner overlapping in various planes of the circuit board.
